(19) United States
(12) Patent Application Publication
(10) Pub. No.: US 2026/0134132 A1
(43) Pub. Date: May 14, 2026

(54) METHODS AND APPARATUS FOR IMPLEMENTING DATA ACCESS WITHIN A FILESYSTEM ACROSS CONTROL PLANES AND DATA PLANES

(71) Applicant: Domino Data Lab, Inc., San Francisco, CA (US)

(72) Inventors: Gabriel HAIM, Redondo Beach, CA (US); Giulio CAPOLINO, Cambridge, MA (US); Eric Yehong JIN, San Francisco, CA (US); Murat CETIN, San Francisco, CA (US)

(73) Assignee: Domino Data Lab, Inc., San Francisco, CA (US)

(21) Appl. No.: 19/379,098

(22) Filed: Nov. 4, 2025

Related U.S. Application Data
(60) Provisional application No. 63/718,060, filed on Nov. 8, 2024.

(51) Int. Cl. G06F 21/62; H04L 9/40

(52) U.S. Cl. CPC G06F 21/6218; H04L 63/105

(57) ABSTRACT

According to an embodiment, a non-transitory, processor-readable medium stores instructions that, when executed by a processor, cause the processor to cause metadata associated with a plurality of filesystems to be displayed at a user compute device via a user interface. At a control plane, an indication of a task is received from the user compute device via the user interface. In response to receiving the indication of the task, the processor automatically causes the task to be routed to a data plane from a plurality of data planes managed by the control plane. Each data plane from the plurality of data planes is associated with a filesystem different from remaining filesystems from the plurality of filesystems. The instructions further cause the processor to cause the data plane to provision a compute resource to execute the task.

### CROSS REFERENCE TO RELATED APPLICATIONS

This application claims priority to and the benefit of U.S. Provisional Patent Application No. 63/718,060, filed Nov. 8, 2024, and entitled “METHODS AND APPARATUS FOR IMPLEMENTING DATA ACCESS WITHIN A FILESYSTEM ACROSS CONTROL PLANES AND DATA PLANES,” the content of which is incorporated herein by reference in its entirety.

### FIELD

One or more embodiments described herein relate to systems and computerized methods for facilitating access to data via a control plane and at least one data plane from a plurality of data planes.

### BACKGROUND

In some instances, a machine-executable task can involve both data that is stored local to a user and data that is stored remote from the user. A regulation or policy can moreover limit access to data based on, for example, a geographic location of a memory that stores the data. A need exists, therefore, for systems and methods configured to govern and facilitate access to locally and remotely stored data.

### SUMMARY

According to an embodiment, a non-transitory, processor-readable medium stores instructions that, when executed by a processor, cause the processor to cause metadata associated with a plurality of filesystems to be displayed at a user compute device via a user interface. At a control plane, an indication of a task is received from the user compute device via the user interface. In response to receiving the indication of the task, the processor automatically causes the task to be routed to a data plane from a plurality of data planes managed by the control plane. Each data plane from the plurality of data planes is associated with a filesystem different from remaining filesystems from the plurality of filesystems. The instructions further cause the processor to cause the data plane to provision a compute resource to execute the task.

According to an embodiment, a method includes receiving, via a processor and at a control plane, an indication of a task from a user compute device via a user interface. In response to receiving the indication of the task, the method includes deploying, via the processor, based on a geographic constraint, and without receiving an indication of a data plane from the user compute device, a web service to the data plane from a plurality of data planes managed by the control plane, the web service configured to (1) detect a compute resource provisioned to the data plane and, (2) in response to detecting the compute resource, register the compute resource at the control plane. In response to the web service detecting the compute resource provisioned to the data plane, the method also includes causing, via the processor, the task to be routed to the data plane for execution.

According to an embodiment, a non-transitory, processor-readable medium stores instructions that, when executed by a processor, cause the processor to receive, at a control plane, an indication of a task from a user compute device via a user interface. In response to the receiving the indication of the task, the instructions cause the processor to deploy a web service to a data plane based on a geographic constraint and without receiving from the user compute device an indication of the data plane, the data plane being from a plurality of data planes managed by the control plane and associated with a plurality of filesystems, the web service being configured to (1) detect a compute resource provisioned to the data plane and, in response to detecting the compute resource, (2) register the compute resource at the control plane. In response to the web service detecting the compute resource provisioned to the data plane, the task is routed to the data plane for execution.

### BRIEF DESCRIPTION OF THE DRAWINGS

FIG. 1 shows a system block diagram of a data management system, according to an embodiment.

FIG. 2 shows a system block diagram of a compute device included in a data management system, according to an embodiment.

FIG. 3 shows a system block diagram of data management components included in a data management system, according to an embodiment.

FIG. 4 shows a system block diagram of a data management system that implements a control plane and a data plane, according to an embodiment.

FIG. 5 shows a flow diagram illustrating a method implemented by a data management system to execute a task via a data plane, according to an embodiment.

FIG. 6 shows a flow diagram illustrating a method implemented by a data management system to route a task to a data plane for execution, according to an embodiment.

### DETAILED DESCRIPTION

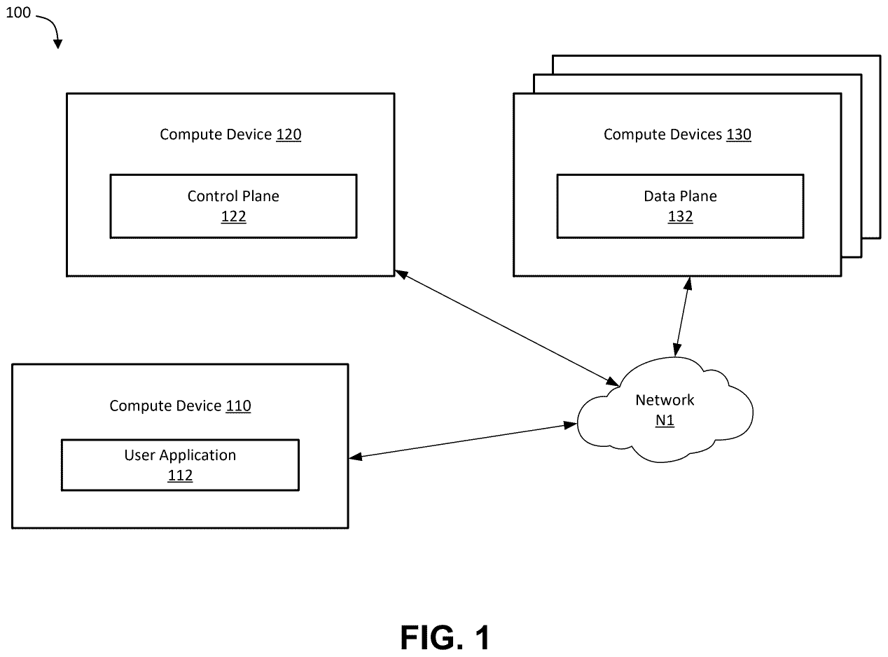

FIG. 1 shows a system block diagram of a data management system 100, according to an embodiment. The data management system 100 includes a compute device 110, a compute device 120 implementing a data plane 122, a plurality of compute devices 130 (each compute device 130 implementing a data plane 132), and a network N1. The data management system 100 can include alternative configurations, and various steps and/or functions of the processes described below can be shared among the various devices of the data management system 100 or can be assigned to specific devices (e.g., the compute device 110, the compute device 120, the compute devices 130, and/or the like). For example, in some configurations, a user can provide inputs directly to the compute device 120 rather than via the compute device 110, as described herein.

In some embodiments, the compute device 110, the compute device 120, and/or the compute devices 130 can include any suitable hardware-based computing devices and/or multimedia devices, such as, for example, a server, a desktop compute device, a smartphone, a tablet, a wearable device, a laptop and/or the like. In some implementations, the compute device 110, the compute device 120, and/or the compute devices 130 can be implemented at an edge (e.g., with respect to the network N1) node or other remote (e.g., with respect to the network N1) computing facility and/or device. In some implementations, each of the compute device 110, the compute device 120, and/or the compute devices 130 can be (or be included in) a data center or other control facility and/or device configured to run and/or execute a distributed computing system and can communicate with other compute devices.

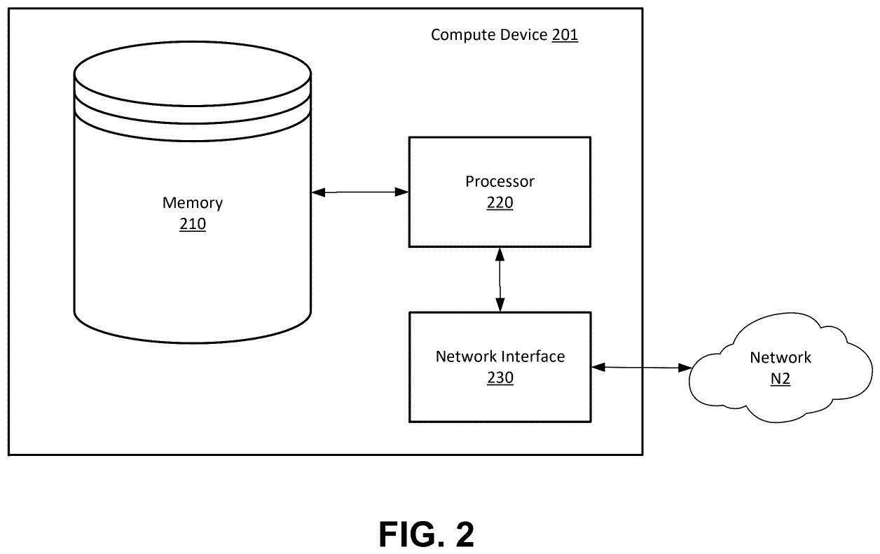

The compute device 110 can execute and/or implement a user application 112, which can include software (1) stored at a memory that is functionally and/or structurally similar to the memory 210 of FIG. 2, discussed below, and (2) executed via a processor that is functionally and/or structurally similar to the processor 220 of FIG. 2, discussed below. The user application 112 can be configured to display, access, and/or manipulate data within a data plane 132 (described further herein) executed at each compute device 130. The user application 112 can be implemented via software and/or hardware.

The compute device 120 can execute and/or implement a control plane 122, which can include software (1) stored at a memory that is functionally and/or structurally similar to the memory 210 of FIG. 2, discussed below, and (2) executed via a processor that is functionally and/or structurally similar to the processor 220 of FIG. 2, discussed below. The control plane 122 can be configured to manage a plurality of data planes 132 implemented by the compute devices 130 (described further herein). For example, the control plane 122 can be configured to select the data plane 132 (described further herein) from a plurality of data planes (not shown in FIG. 1). Additionally, the control plane 122 can be configured to provision compute resources and/or mount memory for the data planes 132, set permissions for the data planes 132, and/or manage configurations of the data planes 132. The control plane 122 can further be configured to manage the states of tasks (e.g., tracking pending tasks, completed tasks, etc.), route task indications received from the user application 112 to one or more data planes 132 to cause the compute device(s) 130 (described herein) executing the one or more data planes 132 to execute the tasks, etc. The control plane 122 can be implemented via software and/or hardware.

The compute devices 130 can each execute and/or implement a different data plane 132, which can include software (1) stored at a memory that functionally and/or structurally similar to the memory 210 of FIG. 2 discussed below and (2) executed via a processor that is functionally and/or structurally similar to the processor 220 of FIG. 2 discussed below. Although not shown in FIG. 1, in some instances, a single compute device 130 can implement a plurality of data planes 132. Alternatively or in addition, a plurality of compute devices 130 can implement a single data plane 132. The data plane 132 can include compute resources (e.g., a database(s) and/or other memory, a central processing unit(s) (CPU(s)), a graphics processing unit(s) (GPU(s)), etc.) that can be configured to execute the task routed to the data plane 132 from the control plane 122. In some instances, the data plane 132 can be a local data plane (e.g., physically collocated with the compute device 110). In some instances, the data plane 132 can be a remote data plane (e.g., physically located remote from the compute device 110, such as in another country, in another jurisdiction, in another room, etc.). The data plane 132 can be implemented via software and/or hardware.

The compute device 110 can be networked and/or communicatively coupled to the compute device 120 and/or the compute devices 130, via the network N1, using wired connections and/or wireless connections. The network N1 can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, free space optical networks and/or various combinations of the foregoing. Such communication can be facilitated by any device capable of transmitting data to and from other compute devices, such as a modem(s) and/or a wireless interface(s).

In some implementations, although not shown in FIG. 1, the data management system 100 can include multiple compute devices 110, compute devices 120, and/or compute devices 130. For example, in some implementations, the data management system 100 can include a plurality of compute devices 110, where each compute device 110 can be associated with a different user from a plurality of users. In some implementations, a plurality of compute devices 110 can be associated with a single user, where each compute device 110 can be associated with, for example, a different input modality (e.g., text input, audio input, video input, etc.). Some implementations can include various combinations of the above. For example, a single control plane 122 can manage a plurality of data planes 132, cause display of representation of metadata stored at and/or across multiple data planes 132 (e.g., cause display of a unified representation, as a single filesystem, of metadata that is distributed across multiple data planes 132), etc., as described further herein.

FIG. 2 shows a system block diagram of a compute device 201 included in a data management system, according to an embodiment. The compute device 201 can be structurally and/or functionally similar to, for example, the compute device 110, 120, and/or 130 of the data management system 100 shown in FIG. 1. The compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. The compute device 201 includes a memory 210, a processor 220, and a network interface 230 operably coupled to a network N2.

The processor 220 can be, for example, a hardware-based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 220 is operatively coupled to the memory 210. In some embodiments, for example, the processor 220 can be coupled to the memory 210 through a system bus (for example, address bus, data bus and/or control bus). In some implementations, the processor 220 can include a plurality of parallelly arranged processors.

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the network interface 230. For example, a remote database server can be operatively coupled to the compute device 201.

The memory 210 can store various instructions associated with processes, algorithms and/or data, as described herein. The memory 210 can further include any non-transitory computer-readable storage medium for storing data and/or software that is executable by processor 220, and/or any other medium which may be used to store information that may be accessed by processor 220 to control the operation of the compute device 201.

The network interface 230 can be configured to connect to the network N2, which can be functionally and/or structurally similar to the network N1 of FIG. 1. For example, network N2 can use any of the communication protocols described above with respect to network N1 of FIG. 1.

In some instances, the compute device 201 can further include a display, an input device, and/or an output interface (not shown in FIG. 2). The display can be any display device (e.g., a monitor, screen, etc.) by which the compute device 201 can output and/or display data (e.g., via a user application that is structurally and/or functionally similar to the user application 112 of FIG. 1). The input device can include a mouse, keyboard, touch screen, voice interface, and/or any other hand-held controller or device or interface via which a user may interact with the compute device 201. The output interface can include a bus, port, and/or other interfaces by which the compute device 201 may connect to and/or output data to other devices and/or peripherals.

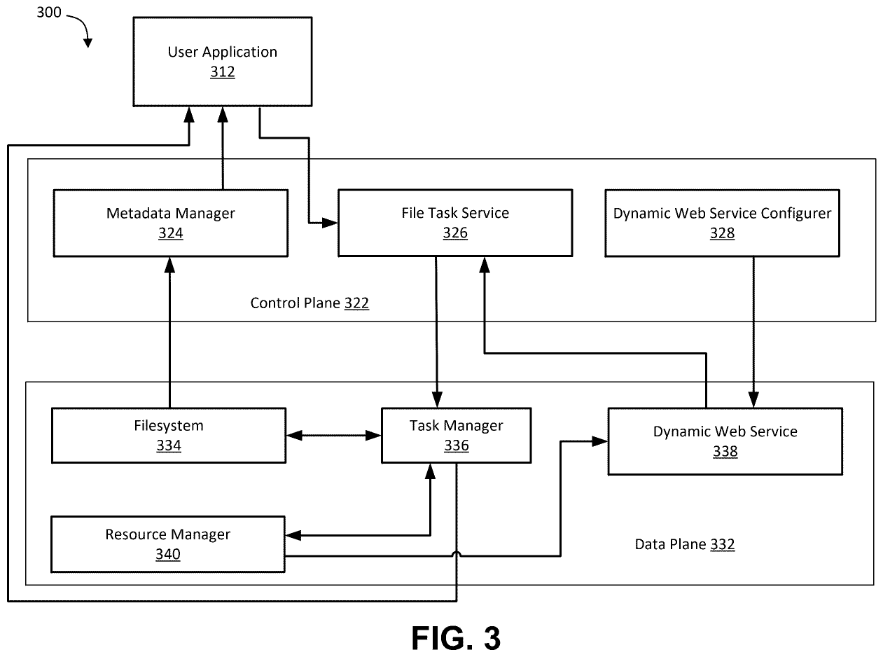

FIG. 3 shows a system block diagram of data management components included in a data management system, according to an embodiment. The data management components 300 can be associated with a compute device (e.g., a compute device that is structurally and/or functionally similar to the compute device 201 of FIG. 2 and/or the compute devices 110, 120, and/or 130 of FIG. 1). For example, the data management components 300 can be included in and/or associated with (1) the user application 112, control plane 122, and/or data plane 132 of FIG. 1 and/or (2) the control plane 222 of FIG. 2. In some instances, the data management components 300 can include software stored in memory 210 and configured to execute via the processor 220 of FIG. 2. In some instances, at least a portion of the data management components 300 can be implemented in hardware (e.g., an ASIC).

The data management components 300 include a user application 312 (e.g., that is functionally and/or structurally similar to the user application 112 of FIG. 1), a control plane 322 (e.g., that is functionally and/or structurally similar to the control plane 122 of FIG. 1 and/or the control plane 222 of FIG. 2), and a data plane 332 (e.g., that is functionally and/or structurally similar to the data plane 132 of FIG. 1 and/or the control plane 232 of FIG. 2). The control plane 322 includes a metadata manager 324 (e.g., that is functionally and/or structurally similar to the metadata manager 224 of FIG. 2), a file task service 326 (e.g., that is functionally and/or structurally similar to the file task service 226 of FIG. 2), and a dynamic web service configurer 328 (e.g., that is functionally and/or structurally similar to the dynamic web service configurer 228 of FIG. 2). The data plane 332 includes a filesystem 334, a task manager 336, a dynamic web service 338, and a resource manager 340.

In some implementations, the user application 312 can include a graphical user interface (GUI) that can be executed at a user compute device (e.g., that is functionally and/or structurally similar to the compute device 110 of FIG. 1). For example, the user application 312 can include a web application that implements the GUI. The user application 312 can cause display, via the GUI, of file metadata associated with the filesystem 334 of the data plane 332 and retrieved from the filesystem 334 via the metadata manager 324 of the control plane 322. The metadata can include, for example, filename data, date data (indicating, for example, file creation date and/or file modification date), file size data, folder and/or file directory structure, file author data, etc., associated with a file(s) of the filesystem 334. In some instances, the user application 312 can cause display of metadata associated with a plurality of filesystems (e.g., that includes the filesystem 334) that are included in (or associated with) a plurality of data planes that includes the data plane 332. Each data plane from the plurality of data planes can be associated with a different virtual data store (e.g., a plurality of factions within a physical data store, such as a server), a different physical data store (e.g., a first server that is remote as to the user compute device that executes the user application 312 and a second server that is local to the user compute device), a different cloud storage service, etc. As a result, the user application 312 can implement an abstracted view of file metadata for files stored in disparate data stores (e.g., data that is stored across local and remote data stores). For example, metadata from different data planes can be displayed (or otherwise presented) via the user application 312 as if (or similar to as if) the metadata was associated with a single filesystem (e.g., displayed as a single folder structure).

Alternatively or in addition to the above, in some implementations, the user application 312 can include an application (e.g., a machine learning platform, a data science tool, a data editing software, etc.) that can read data from and/or write data to the filesystem 334. In some implementations, the metadata manager 324 can be configured to persist metadata to the user application 312 provided that a user associated with the user application 312 has a sufficient permission level and/or access to view that metadata. In some implementations, the metadata manager 324 can forward, at a first time, metadata from the filesystem 334 that is associated with a snapshot from a second time that is before the first time. For example, the filesystem 334 can be configured to cause file data and/or file metadata to be captured and stored at a plurality of times. Each time can be based on a predefined frequency, a change to the filesystem 334 (e.g., a file modification, a file creation, a file deletion, etc.), and/or a user-defined request to create a snapshot. A user can view a snapshot of metadata from a plurality of snapshots via the user application 312 by indicating, for example, a desired time for the snapshot.

A user can initiate a task via the user application 312 to read data from and/or cause modification to a file associated with metadata that is displayed via the user application 312. An example(s) of a task can include copying data, sizing data, deleting data, writing data, and/or reading data. In some instances, a task can include, for example, a data science task, such as a machine learning operation (e.g., a data cleaning task, a machine learning training task, a machine learning inferencing task, etc.). The file task service 326 can receive an indication of the task from the user application 312 and, in response, the file task service 326 can select the data plane 332 from a plurality of data planes (not shown in FIG. 3). In some instances, the file task service 326 can select the data plane 332 from the plurality of data planes based on the data plane 332 storing a file(s) that the task involves. In some instances, the file task service 326 can select the data plane 332 from the plurality of data planes based on a task type associated with the task. For example, the task type can indicate that the task is a machine learning operations (ML Ops) task that involves CPU bandwidth, GPU bandwidth, an amount of memory, etc. The file task service 326 can route the task to the data plane 332 based on the data plane 332 having sufficient compute resources to perform the task having the task type. Alternatively or in addition, in some implementations, the file task service 326 can implement a load balancing protocol by routing a task to the data plane 332 based on the data plane 332 having more compute resource availability (e.g., less data traffic) than remaining data planes from the plurality of data planes.

In some implementations, a task can involve (e.g., be specific to) metadata of a dataset entity of a control plane 322. A dataset entity can include a representation of a filesystem 334 (described herein) of a control plane 332. The dataset entity can be displayed to (or otherwise accessed by) a user via the user application 312. A dataset entity metadata task can include, for example, a dataset name change, a dataset permission change, an association (or disassociation) of an organization with the dataset entity, tagging a dataset with a label, associating the dataset with a project, etc. These metadata tasks can, in some instances, be performed at the control plane 322 and not the data plane 332. In some implementations, a task can include a change to file data and/or file metadata. The control plane 322 can route these tasks to the data plane 332 (and/or other data planes that store the file data and/or file metadata). The data plane 332 can execute the task and cause the dataset metadata at the control plane 332 to be updated accordingly. The control plane 322 can be further configured to manage user permissions (e.g., global permissions) to control access to data within the data plane 332.

As described above, the plurality of data planes can be associated with, for example, a plurality of geographic locations (e.g., states, countries, continents, regions, etc.). For example, the plurality of data planes can be implemented by a plurality of servers (e.g., that are functionally and/or structurally similar to the compute devices 130 of FIG. 1) disposed in a plurality of geographic locations. The file task service 326 can select the data plane 332 from the plurality of data planes after checking that a permission (e.g., global permissions) associated with the user application 312 permit the user application 312 to access the data plane 332. The file task service 326 can further select the data plane 332 based on a constraint (e.g., a regulation, requirement, etc.), such as a geographic location constraint. For example, a constraint can cause a user compute device disposed in a first geographic location (e.g., the United States) to have access to a first server disposed in the first geographic location but not a second server disposed in a second geographic location (e.g., Europe) different from the first geographic location. In some instances, this user compute device can still cause display, via the user application 312, of metadata that is stored at the second server that the user compute device does not otherwise have access to due to the constraint.

For example, data stored at data planes located in different geographic locations and/or jurisdictions can be maintained separately (and according to the laws, regulations and/or customs) of the jurisdiction in which that data is maintained. If, for example, a jurisdiction has a regulation that a user device accessing the data (e.g., via a user application 312) must be located in the same jurisdiction in which the data is stored (or not within a certain geographic location, such as a sanctioned country), the control plane 322 can obtain confirmation of a geographic location of the user device (e.g., GPS location, Wi-Fi access point location, etc.) before allowing access to that data and/or that data plane. In this manner, jurisdictional laws, regulations and/or customs on data storage and access can be maintained while still providing a unified view of the metadata to the user (e.g., via a common filesystem and/or folder structure).

In response to selecting the data plane 332, the task manager 336 can route the task to the data plane 332 to execute, at that data plane 332, the task (also referred to as performing an execution) indicated via the user application 312. More specifically, the task manager 336 can cause the resource manager 340 to provision (e.g., spool up) compute resources (e.g., a central processing unit(s) (CPU(s)), a graphics processing unit(s) (GPU(s)), memory, etc.) to perform the task (e.g., a data science task). Resources can be provisioned in the same cluster as the data associated with the task, such that the task can be performed on the data. In at least some instances, provisioning and/or spooling up compute resources at the data plane level (e.g., the level that implements the compute resources) within the same cluster can be performed more efficiently than provisioning and/or spooling up the compute resources at the control plane level, at a different data plane, and/or within a different cluster. Alternatively or in addition, the task manager 336 can access data (e.g., training data, pipeline data, etc.) within the filesystem 334 to perform the task. In response to performing the task, the task manager 336 can return output data (e.g., prediction data, file data, etc.) to the user application 312.

In some implementations, the task manager 336 can provide the output data to the user application 312 without providing the output data to the control plane 322, such that privacy and/or security of the output data can be maintained. Moreover, as a result of the control plane 322 not having access to the data stored at the data plane 332, the control plane 332 being implemented via a first compute device at a first geographic location (or can be managed by a first organization) and facilitate management of data stored at second compute device stored a second geographic location (or stored and/or managed within a second organization), even if the first compute device and/or first organization does not have access to the data. Alternatively or in addition, the control plane 332 can permit a user to view and/or manipulate local data to the user (e.g., data stored at a compute device that is coupled to the same network as a user compute device of the user and/or at a compute device that is proximal to the user), which the user can perform more efficiently than with remote data (e.g., due to bandwidth, network traffic, network latency, etc.), while still permitting the user to view both remote and local data in an integrated view.

For example, a single control plane can manage a data plane in a first geographic location (e.g., first jurisdiction, country, state, etc.) storing data according to the laws, regulations and/or customs of the first geographic location and a data plane in a second geographic location (e.g., second jurisdiction, country, state, etc.) storing data according to the laws, regulations and/or customs of the second geographic location. The control plane can be located in the first geographic location, second geographic location, or a third geographic location. The control plane can present the metadata for the data stored by the data plane in the first geographic location and the metadata for the data stored by the data plane in the second geographic location in a single unified view to a user of the user application (e.g., as a single filesystem, a single folder structure, etc.). Because the laws, regulations and/or customs between the different geographic locations may vary, the control plane can direct tasks to the first data plane or the second data plane based on the data stored and/or tasks performed at the first data plane and the second data plane (e.g., based on which data is selected to be modified and/or accessed at the user application and/or based on which task is to be performed as selected at the user application). When data to be manipulated and/or accessed is stored at the first data plane, the data can be maintained separate from (e.g., walled from) the second data plane and the control plane. Specifically, a request can be directed to the first data plane from the control plane, but the underlying data can be provided to the user application 312 directly from the data plane (and not via the control plane) to maintain separation between this data and the control plane and other data planes. Moreover, any change to the metadata of the data (e.g., based on changes to the underlying data), can be propagated from the relevant data plane to the control plane, which the underlying data is not sent to the control plane. This allows a single control plane to manage data stored at data planes in jurisdictions having different data privacy laws, regulations and/or customs.

The control plane 322 can further include a dynamic web service configurer 328, which can configure and/or deploy the dynamic web service 338 of the data plane 332 to detect addition and/or removal of a compute resource (e.g., storage memory) at the data plane 332. For example, the resource manager 340 can detect if storage (e.g., memory associated with a storage service, such as a cloud storage service and/or the like), CPU resources, GPU resource, etc., have been added to the data plane. In response to detecting the newly added compute resources, the resource manager 340 can cause the dynamic web service 338 to register the newly added compute resources at the control plane 322. As a result, the file task service 326 can cause a task to be automatically (e.g., without human intervention) routed to the data plane 332 based on the added compute resources (e.g., whereas prior to registration of the additional compute resources, the file task service 326 would have detected that the data plane 332 did not have sufficient compute resources and/or sufficient data to perform the task, routing the task instead, therefore, to another data plane). Additionally, in response to detecting the newly added compute resources, the control plane 322 can collect, at the metadata manager 324, metadata associated with the newly added compute resources (e.g., metadata stored at storage added to the data plane 332) and cause display of the metadata via the user application 312.

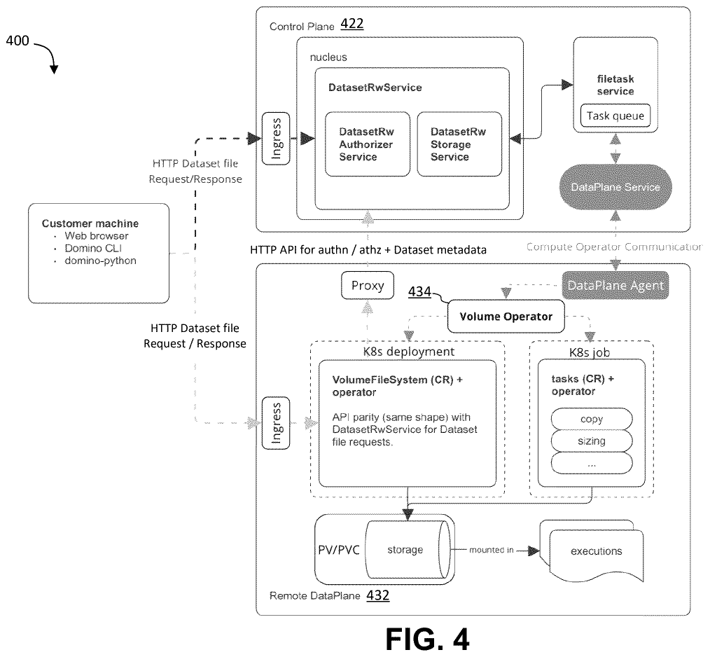

FIG. 4 shows a system block diagram of a data management system 400 that implements a control plane 422 and a data plane 432, according to an embodiment. The data management system 400 can be functionally and/or structurally similar to the data management system 100 of FIG. 1 and/or the data management system 400 of FIG. 4. The control plane 422 can be functionally and/or structurally similar to the control plane 122 of FIG. 1, the control plane 222 of FIG. 2, and/or the control plane 322 of FIG. 3. The data plane 432 can be functionally and/or structurally similar to the data plane 132 of FIG. 1 and/or the data plane 332 of FIG. 3.

The data management system 400 can implement operators to deploy resources to manage dataset operations like snapshotting and/or file system operations on remote and/or local data planes. For example, the data management system 400 can implement custom resource definitions (CRDs) and associated operators (e.g., Kubernetes CRDs and associated operators, and/or the like) that can be created and/or edited upon request in remote data planes. The custom resources (CRs) defined by the CRDs, in addition to a Filetask service, can communicate with a data plane service to coordinate dataset operations, such as managing file tasks, managing dataset file operations, and/or managing send/receive logs.

An example of a custom resource (CR) can include, for example, a Kubernetes formalized version of tasks (referred to herein as a tasks CR) executed at the dataset level, such as copying, sizing, and/or deleting datasets and/or snapshots. These tasks can include asynchronous tasks, and the CR can be configured to perform the asynchronous tasks while executing Kubernetes jobs as a background process. The data plane service can forward creating, reading, updating, and deleting (CRUD) operations to this CR, as requested by the Filetask service. The Kubernetes operator, Volume Operator 434, can manage provisioning (e.g., spinning up) and/or executing new jobs. The Volume Operator 434 of the data plane 430 can further be configured to govern the number of concurrent tasks and/or jobs that can be run, along with the queuing and/or job-resilience persistence logic, facilitating environment management.

A further example of a CR implemented by the data management system 400 includes a VolumeFileSystem (VFS) service, which can include a long running deployment in a remote data plane that can conduct synchronous dataset file operations on an associated remote filesystem (e.g., elastic filesystem (EFS) and/or the like). Synchronous dataset file operations can include an operation that involves the underlying files and/or folders within datasets, including read-only and read-write snapshots. An asynchronous dataset file operation (e.g., a dataset file operation that takes longer to execute and/or is more resource intensive than a synchronous dataset file operation) can involve the overall dataset managed by the tasks CR described above. For example, retrieving files within a snapshot, sending file upload chunks, retrieving snapshot file metadata, etc., are examples of synchronous dataset file operations, while moving a snapshot folder for deletion is an example of an asynchronous dataset file operation.

In some implementations, requests can be sent from a user compute device (e.g., functionally and/or structurally similar to the compute device 110 of FIG. 1) that is in the same network (e.g., functionally and/or structurally similar to the network N1 of FIG. 1 and/or the network N2 of FIG. 2) as the data plane to the VFS service. These requests can be excluded from flowing from the control plane 422 and/or a local data plane to the remote data plane. In some instances, an ingress rule (e.g., a location directive) can be added to a data plane web server ingress (an nginx ingress) to reverse proxy requests to the VFS service.

To keep application programming interfaces (APIs) consistent between local and remote data planes, the VFS service can have API parity with a plurality of dataset file operations. Additionally, the VFS service can be configured to call a remote procedure call (RPC) style API in a Dataset Authorizer service to handle permissions. The Dataset Authorizer can be included in (or associated with) the control plane 422 and can include a set of APIs. These APIs can be associated with a permission framework that is managed by the control plane 422 and that governs permissions (e.g., access) to a dataset entity of the control plane 422. The dataset entity can include, for example, a representation of metadata associated with the data plane 432. The VFS service can be further configured to call at least one RESTful API (e.g., a first API call for datasets and a second API call for snapshots) in the dataset service to retrieve dataset storage information. The at least one RESTful API can compensate for the VFS service not persisting dataset information, which can be used to determine an associated mount path to perform operations on.

The data management system 400 can permit dataset users to cause dataset operations to be performed without defining where the data resides. If a user has data locality and/or security constraints (e.g., as to where data is stored), the data management system 400 can satisfy these constraints without causing a significant (e.g., perceptible) change to the user's workflows and/or operations.

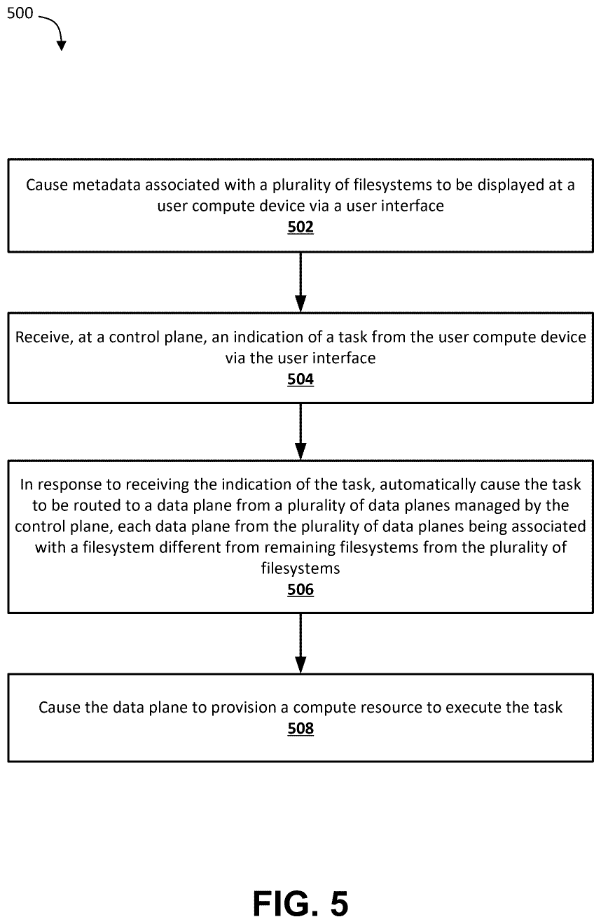

FIG. 5 shows a flow diagram illustrating a method 500 implemented by a data management system to execute a task via a data plane, according to an embodiment. The method 500 can be implemented by a data management system described herein (e.g., the data management system 100 of FIG. 1 and/or the data management system 400 of FIG. 4). Portions of the method 500 can be implemented using a processor (e.g., the processor 220 of FIG. 2) of any suitable compute device (e.g., the compute device 201 of FIG. 2 and/or the compute devices 110, 120, and/or 130 of FIG. 1).

The method 500, at 502, includes causing metadata associated with a plurality of filesystems to be displayed at a user compute device via a user interface. At 504, the method 500 includes receiving, at a control plane, an indication of a task from the user compute device via the user interface. At 506, in response to receiving the indication of the task, the task is automatically routed to a data plane from a plurality of data planes managed by the control plane, each data plane from the plurality of data planes being associated with a filesystem different from remaining filesystems from the plurality of filesystems. At 508, the data plane provisions a compute resource to execute the task.

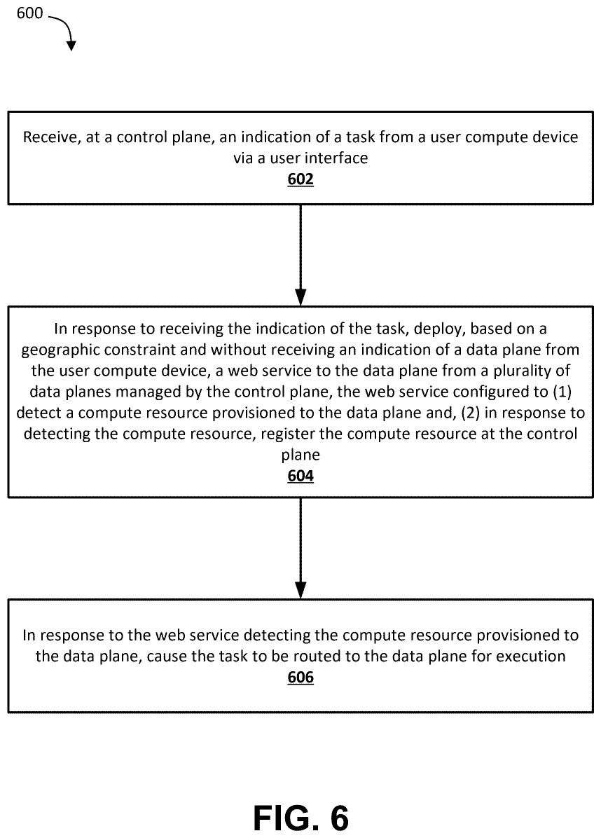

FIG. 6 shows a flow diagram illustrating a method 600 implemented by a data management system to route a task to a data plane for execution, according to an embodiment. The method 600 at 602 includes receiving, via a processor and at a control plane, an indication of a task from a user compute device via a user interface. In response to receiving the indication of the task, at 604, the method 600 includes deploying, via the processor, based on a geographic constraint, and without receiving an indication of a data plane from the user compute device, a web service to the data plane from a plurality of data planes managed by the control plane, the web service configured to (1) detect a compute resource provisioned to the data plane and, (2) in response to detecting the compute resource, register the compute resource at the control plane. In response to the web service detecting the compute resource provisioned to the data plane, the method 600 at 606 includes causing, via the processor, the task to be routed to the data plane for execution.

According to an embodiment, a non-transitory, processor-readable medium stores instructions that, when executed by a processor, cause the processor to cause metadata associated with a plurality of filesystems to be displayed at a user compute device via a user interface and receive, at a control plane, an indication of a task from the user compute device via the user interface. In response to receiving the indication of the task, the task is automatically routed to a data plane from a plurality of data planes managed by the control plane, each data plane from the plurality of data planes being associated with a filesystem different from remaining filesystems from the plurality of filesystems. The instructions also cause the processor to cause the data plane to provision a compute resource to execute the task.

In some implementations, the compute resource includes a storage service, and the non-transitory, processor-readable medium further stores instructions to cause the processor to deploy a web service at the data plane, the web service configured to detect the storage service being provisioned to the data plane. In response to the web service detecting the storage service, the instructions also cause the processor to register the storage service to execute the task.

In some implementations, the instructions to cause the processor to cause the task to be routed to the data plane include instructions to cause the task to be routed to the data plane based on a task type associated with the task. In some implementations, the non-transitory, processor-readable medium further stores instructions to cause the processor to check a permission level associated with the user compute device before causing the task to be routed to the data plane. In some implementations, the filesystem associated with the data plane includes a local filesystem, and in response to the data plane executing the task, the user compute device receives local data from the local filesystem. Additionally, the control plane is excluded from receiving the local data.

In some implementations, the instructions to cause the processor to cause the task to be routed to the data plane include instructions to cause the task to be routed to the data plane based on a geographic constraint. In some implementations, the instructions to cause the processor to cause the task to be routed to the data plane exclude instructions to receive, from the user compute device, an indication of at least one of the data plane or the compute resource associated with the data plane.

In some implementations, the task includes at least one of copying data, sizing data, deleting data, writing data, or reading data. In some implementations, the task is a first task, and the non-transitory, processor-readable medium further stores instructions to cause the processor to cause a second task to be executed at the control plane based on a task type associated with the first task.

According to an embodiment, a method includes receiving, via a processor and at a control plane, an indication of a task from a user compute device via a user interface. In response to receiving the indication of the task, the method includes deploying, via the processor, based on a geographic constraint, and without receiving an indication of a data plane from the user compute device, a web service to the data plane from a plurality of data planes managed by the control plane, the web service configured to (1) detect a compute resource provisioned to the data plane and, (2) in response to detecting the compute resource, register the compute resource at the control plane. In response to the web service detecting the compute resource provisioned to the data plane, the method also includes causing, via the processor, the task to be routed to the data plane for execution.

In some implementations, each data plane from the plurality of data planes is associated with a different filesystem from a plurality of filesystems, and the method further includes, in response to the task being executed at the data plane, updating, via the processor and at the control plane, metadata associated with a filesystem associated with the data plane. Additionally, the method includes causing, via the processor, the metadata to be displayed at the user compute device.

In some implementations, the method further includes checking, via the processor, a permission level associated with the user compute device before causing the task to be routed to the data plane. In some implementations, the data plane is associated with a local filesystem, and in response to the task being executed at the data plane, the user compute device receives local data from the local filesystem. Additionally, the method includes excluding the control plane from receiving the local data.

In some implementations, the causing the task to be routed to the data plane includes causing, via the processor, the task to be routed to the data plane based on a task type associated with the task. In some implementations, the task includes at least one of copying data, sizing data, deleting data, writing data, or reading data. In some implementations, the task is a first task, and the method further includes causing a second task to be executed at the control plane based on a task type associated with the first task.

According to an embodiment, a non-transitory, processor-readable medium stores instructions that, when executed by a processor, cause the processor to receive, at a control plane, an indication of a task from a user compute device via a user interface. In response to the receiving the indication of the task, the instructions cause the processor to deploy a web service to a data plane based on a geographic constraint and without receiving from the user compute device an indication of the data plane, the data plane being from a plurality of data planes managed by the control plane and associated with a plurality of filesystems, the web service being configured to (1) detect a compute resource provisioned to the data plane and, in response to detecting the compute resource, (2) register the compute resource at the control plane. In response to the web service detecting the compute resource provisioned to the data plane, the task is routed to the data plane for execution.

In some implementations, the task includes a metadata task associated with a filesystem (1) from the plurality of filesystems and (2) associated with the data plane, the metadata task including at least one of a dataset name change, a dataset permission change, an association or disassociation of an organization with a dataset, tagging the dataset with a label, or associating the dataset with a project. In some implementations, the non-transitory, processor-readable medium further stores instructions to cause the processor to cause, via the control plane, metadata associated with (1) the plurality of data planes and (2) the plurality of filesystems to be displayed, at the user compute device, as metadata associated with a single filesystem. In some implementations, the data plane implements a local filesystem from the plurality of filesystems. In response to the data plane executing the task, the user compute device receives local data from the local filesystem, and the control plane is excluded from receiving the local data.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A non-transitory, processor-readable medium storing instructions that, when executed by a processor, cause the processor to:
cause metadata associated with a plurality of filesystems to be displayed at a user compute device via a user interface;
receive, at a control plane, an indication of a task from the user compute device via the user interface;
in response to receiving the indication of the task, automatically cause the task to be routed to a data plane from a plurality of data planes managed by the control plane, each data plane from the plurality of data planes being associated with a filesystem different from remaining filesystems from the plurality of filesystems; and
cause the data plane to provision a compute resource to execute the task.

2. The non-transitory, processor-readable medium of claim 1, wherein the compute resource includes a storage service, the non-transitory, processor-readable medium further storing instructions to cause the processor to:
deploy a web service at the data plane, the web service configured to detect the storage service being provisioned to the data plane; and
in response to the web service detecting the storage service, register the storage service to execute the task.

3. The non-transitory, processor-readable medium of claim 1, wherein the instructions to cause the processor to cause the task to be routed to the data plane include instructions to cause the task to be routed to the data plane based on a task type associated with the task.

4. The non-transitory, processor-readable medium of claim 1, further storing instructions to cause the processor to check a permission level associated with the user compute device before causing the task to be routed to the data plane.

5. The non-transitory, processor-readable medium of claim 1, wherein:
the filesystem associated with the data plane includes a local filesystem;
in response to the data plane executing the task, the user compute device receives local data from the local filesystem; and
the control plane is excluded from receiving the local data.

6. The non-transitory, processor-readable medium of claim 1, wherein the instructions to cause the processor to cause the task to be routed to the data plane include instructions to cause the task to be routed to the data plane based on a geographic constraint.

7. The non-transitory, processor-readable medium of claim 1, wherein the instructions to cause the processor to cause the task to be routed to the data plane exclude instructions to receive, from the user compute device, an indication of at least one of the data plane or the compute resource associated with the data plane.

8. The non-transitory, processor-readable medium of claim 1, wherein the task includes at least one of copying data, sizing data, deleting data, writing data, or reading data.

9. The non-transitory, processor-readable medium of claim 1, wherein the task is a first task, the non-transitory, processor-readable medium further storing instructions to cause the processor to cause a second task to be executed at the control plane based on a task type associated with the first task.

10. A method, comprising:
receiving, via a processor and at a control plane, an indication of a task from a user compute device via a user interface;
in response to the receiving the indication of the task, deploying, via the processor, based on a geographic constraint, and without receiving an indication of a data plane from the user compute device, a web service to the data plane from a plurality of data planes managed by the control plane, the web service configured to (1) detect a compute resource provisioned to the data plane and, (2) in response to detecting the compute resource, register the compute resource at the control plane; and
in response to the web service detecting the compute resource provisioned to the data plane, causing, via the processor, the task to be routed to the data plane for execution.

11. The method of claim 10, wherein:
each data plane from the plurality of data planes is associated with a different filesystem from a plurality of filesystems; and
the method further comprises:
in response to the task being executed at the data plane, updating, via the processor and at the control plane, metadata associated with a filesystem associated with the data plane, and
causing, via the processor, the metadata to be displayed at the user compute device.

12. The method of claim 10, further comprising:
checking, via the processor, a permission level associated with the user compute device before causing the task to be routed to the data plane.

13. The method of claim 10, wherein:
the data plane is associated with a local filesystem;
in response to the task being executed at the data plane, the user compute device receives local data from the local filesystem; and
the method further comprises excluding the control plane from receiving the local data.

14. The method of claim 10, wherein:
the causing the task to be routed to the data plane includes causing, via the processor, the task to be routed to the data plane based on a task type associated with the task.

15. The method of claim 10, wherein the task includes at least one of copying data, sizing data, deleting data, writing data, or reading data.

16. The method of claim 10, wherein the task is a first task, the method further comprising causing a second task to be executed at the control plane based on a task type associated with the first task.

17. A non-transitory, processor-readable medium storing instructions that, when executed by a processor, cause the processor to:
receive, at a control plane, an indication of a task from a user compute device via a user interface;
in response to the receiving the indication of the task, deploy a web service to a data plane based on a geographic constraint and without receiving from the user compute device an indication of the data plane, the data plane being from a plurality of data planes managed by the control plane and associated with a plurality of filesystems, the web service being configured to (1) detect a compute resource provisioned to the data plane and, in response to detecting the compute resource, (2) register the compute resource at the control plane; and
in response to the web service detecting the compute resource provisioned to the data plane, cause the task to be routed to the data plane for execution.

18. The non-transitory, processor-readable medium of claim 17, wherein the task includes a metadata task associated with a filesystem (1) from the plurality of filesystems and (2) associated with the data plane, the metadata task including at least one of a dataset name change, a dataset permission change, an association or disassociation of an organization with a dataset, tagging the dataset with a label, or associating the dataset with a project.

19. The non-transitory, processor-readable medium of claim 17, further storing instructions to cause the processor to:
cause, via the control plane, metadata associated with (1) the plurality of data planes and (2) the plurality of filesystems to be displayed, at the user compute device, as metadata associated with a single filesystem.

20. The non-transitory, processor-readable medium of claim 17, wherein:
the data plane implements a local filesystem from the plurality of filesystems;
in response to the data plane executing the task, the user compute device receives local data from the local filesystem; and
the control plane is excluded from receiving the local data.
